(19) United States
(12) Patent Application Publication
(10) Pub. No.: US 2013/0212044 A1
(43) Pub. Date: Aug. 15, 2013

(54) SYSTEM AND MEHTOD FOR MANAGING A DISTRIBUTION NETWORK OF INVESTMENT MONEY

(71) Applicants: Ki Hoon Lee, Seoul (KR); Jin Heung Bae, Seoul (KR)

(72) Inventors: Ki Hoon Lee, Seoul (KR); Jin Heung Bae, Seoul (KR)

(73) Assignee: Samsung Securities Co., Ltd., Seoul (KR)

(21) Appl. No.: 13/820,752

(22) PCT Filed: Sep. 6, 2011
(86) PCT No.: PCT/KR2011/006585

§ 371 Date: May 6, 2013

(30) Foreign Application Priority Data
Sep. 6, 2010 (KR) 10-2010-0086860

(51) Int. Cl. G06Q 40/06

(52) U.S. Cl. CPC G06Q 40/06
USPC 705/36 R

(57) ABSTRACT

This disclosure relates to a system and method for managing a distribution channel of investment money of a customer, which includes a plurality of modules systematically disposed in a communication pipeline of an IM managing backbone server, so that when an IM rebalancing opportunity situation occurs, a plurality of units, possessed by a customer, is guided to form a set of IM rebalancing distribution channel networks where the units are densely connected each other like a mesh, so that a customer or IM management company may not simplify but diversify rebalancing paths of IPs or IP portfolio into various patterns and therefore effectively enjoy resultant economic benefits.

### TECHNICAL FIELD

This disclosure relates to a system and method for managing a distribution channel of investment money (hereinafter, referred to as “IM”) of a customer, and more particularly, to a system and method for managing an IM distribution channel, wherein, when a set of IM rebalancing opportunity situations occurs, a plurality of units (here, the unit means a financial product management unit such as <bank account>, <account>, <virtual account>, <unified managed account (UMA)> or the like), possessed by a customer, is guided to be rebalanced according to a preset quantity, amount or importance while forming a set of IM rebalancing distribution channel networks (or, investment product rebalancing distribution channel network) where the units are densely connected to each other like a mesh according to a set of preset serial rebalancing distribution channels or chainlike rebalancing distribution channels, instead of automatic simple ordering, so that a customer or IM management company (for example, a stock trading company or the like) may be guided not to simplify but to diversify rebalancing paths of investment products (hereinafter, referred to as “IP”) or IP portfolio into various patterns and therefore effectively enjoy resultant economic benefits.

### BACKGROUND ART

Recently, along with a rapidly expanding economic size, the number of customers (personal customers, company customers or the like) managing IM is rapidly increasing. Accordingly, the importance of an IM management company (for example, a stock trading company or the like) generally managing an IM of a customer is also greatly increasing.

Generally, under such a general system, as shown in FIG. 1, an IM managing backbone server 1 for general computerized investment/management of a customer IM 2 uses units connected to various IPs to invest the customer IM 2 in high risk IPs such as <corporate bond with a low credit rating>, <stock>, <capital unprotected equity linked securities (ELS)>, <stock fund seeking a profit in a market return level>, <stock fund seeking a profit over a market return level>, <derivative product>, <investment fund>, <credit stock trading>, <equity linked warrant (ELW)>, <futures/options> or the like, or invest in low risk IPs such as <money market fund (MMF)>, <repurchase paper>, <cash management account (CMA)>, <national bond>, <local bond>, <guaranteed bond>, <bank debenture>, <corporate bond with a high credit rating>, <bond fund>, <capital guarantee ELS> or the like.

Under such a general system, a high risk IP, a low risk IP or the like inevitably exhibits frequent volatility of liquidity according to rapid changes of its social and economic environments. Therefore, in some cases, it is more advantageous to possess high risk IPs further, and in some cases, it is more advantageous to possess low risk IPs further.

For example, when a stock price or relevant index gets relatively higher or a subsidiary trading index considering market supply and demand represents sale or overestimated stock price (at upside breakout of a Bollinger band, appearance of MACD sell signal, or candle pattern sell signal), possessing low risk IPs more is advantageous than possessing high risk IPs more. In an inverse case, possessing high risk IPs more is advantageous than possessing low risk IPs more.

After thoroughly considering the above, if a stock price or relevant index gets relatively higher or a subsidiary trading index considering market supply and demand represents sale or overestimated stock price (at upside breakout of a Bollinger band, appearance of MACD sell signal, or candle pattern sell signal), the general IM managing backbone server 1 rebalances IM of a unit A to a unit B so that a customer may possess low risk IPs more. In an inverse case, the general IM managing backbone server 1 rebalances IM of the unit B into the unit A so that a customer may possess high risk IPs more.

If the IM managing backbone server 1 performs such rebalancing measures, even though the financial market exhibits frequent volatility of liquidity or the like, a customer may manage his IM under a more advantageous condition.

However, in the above system, as described above, the IM managing backbone server 1 just fragmentarily takes only a set of <bidirectional balancing measures> with respect to relative single units of the customer, namely the units A and B. Therefore, despite the management of the IM managing backbone server 1, the rebalancing path of the customer IP is inevitably simplified to a bidirectional relation between the single units A and B. As a result, the portfolio of IPs possessed by the customer inevitably exhibits an extremely simple pattern.

If the rebalancing path or portfolio of the customer IP is simplified as described above, even though the IM managing backbone server 1 takes a rebalancing measure, the corresponding customer may not stably manage his asset value and cannot avoid various tangible/intangible losses accordingly.

Under the circumstance where the above problems are still present, if there is no separate countermeasure, each customer cannot help but passively manage the IM 2. As a result, each IM management company cannot avoid a great damage in the overall asset investment market.

### DISCLOSURE

### Technical Problem

This disclosure is directed to systematically disposing and associating <a computing module capable of checking a change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units or a change situation (for example, various index and indicator situations, news situations, external event occurrence situations or the like) of an IP-belonged financial market>, <a computing module capable of comparing the checked change situation of the customer-possessing IP or the checked change situation of the IP-belonged financial market with IM rebalancing distribution channel setting information, previously stored, and determining whether the corresponding change situation corresponds to an opportunity situation where the IM needs to be rebalanced>, <a computing module capable of, in case the change situation of the customer-possessing IP or the change situation of the IP-belonged financial market corresponds to an opportunity situation where the IM needs to be rebalanced, generating IM rebalancing execution information for the plurality of customer-possessing units according to the IM rebalancing distribution channel setting information and transmitting the generated IM rebalancing execution information to the IM managing backbone server so that a set of IM rebalancing executing procedures is performed to the plurality of customer-possessing units under complex relationships thereof> or the like in a communication pipeline of an IM managing backbone server, whereby when an IM rebalancing opportunity situation occurs, the plurality of customer-possessing units is guided to be rebalanced according to a preset quantity, amount or importance while forming a set of IM rebalancing distribution channel networks (or, investment product rebalancing distribution channel network) where the units are densely connected each other like a mesh according to a set of preset serial rebalancing distribution channels or chainlike rebalancing distribution channels, instead of automatic simple ordering, so that a customer or IM management company (for example, a stock trading company or the like) may be guided not to simplify but to diversify rebalancing paths of investment products (hereinafter, referred to as “IP”) or IP portfolio into various patterns and therefore effectively enjoy resultant economic benefits.

Other objects of the present disclosure will become more apparent from the following detailed description and the accompanying drawings.

### Technical Solution

In one general aspect, there is provided a system for managing a distribution channel of investment money (IM), which includes: an IM distribution channel management control module for communicating with an IM managing backbone server, which performs computerized management for a process of investing investment money (IM) of a customer to investment products (IP), storing IM rebalancing distribution channel setting information associated with rebalancing of the IM, and controlling a managing procedure of the IM, by means of a plurality of customer-possessing units; an IP/market change situation checking module controlled by the IM distribution channel management control module to communicate with the IM managing backbone server and check a change situation of an IP connected to the plurality of customer-possessing units or a change situation of an IP-belonged financial market where the IP is belonged; an IM rebalancing opportunity occurrence determining module controlled by the IM distribution channel management control module to communicate with the IP/market change situation checking module, check a change situation of an customer-possessing IP or a change situation of the IP-belonged financial market, then compare the checked change situation of the customer-possessing IP or the checked change situation of the IP-belonged financial market with the IM rebalancing distribution channel setting information, previously stored, and determine whether the corresponding change situation corresponds to an opportunity situation where the IM needs to be rebalanced; an IM rebalancing execution information generating module controlled by the IM distribution channel management control module, wherein in case the change situation of the customer-possessing IP or the change situation of the IP-belonged financial market corresponds to an opportunity situation where the IM needs to be rebalanced, the IM rebalancing execution information generating module generates IM rebalancing execution information for the plurality of customer-possessing units according to the IM rebalancing distribution channel setting information; and an IM rebalancing execution notifying module controlled by the IM distribution channel management control module to transmit the IM rebalancing execution information to the IM managing backbone server so that an IM rebalancing executing procedure is performed to the plurality of customer-possessing units, subject to computerized management of the IM managing backbone server, under complex relationships thereof.

In another general aspect, there is provided a method for managing a distribution channel of IM, which includes: communicating with an IM managing backbone server, which performs computerized management for a process of investing investment money (IM) of a customer to investment products (IP) to check a change situation of a customer-possessing IP connected to the plurality of customer-possessing units or a change situation of an IP-belonged financial market which the IP belongs to; comparing the checked change situation of the customer-possessing IP or the checked change situation of the IP-belonged financial market with <IM rebalancing distribution channel setting information, previously stored, associated with rebalancing of the IM> and determining whether the corresponding change situation corresponds to an opportunity situation where the IM needs to be rebalanced; generating IM rebalancing execution information for the plurality of customer-possessing units according to the IM rebalancing distribution channel setting information in case the change situation of the customer-possessing IP or the change situation of the IP-belonged financial market corresponds to an opportunity situation where the IM needs to be rebalanced; and transmitting the IM rebalancing execution information to the IM managing backbone server so that an IM rebalancing executing procedure is performed to the plurality of customer-possessing units, subject to computerized management of the IM managing backbone server, under complex relationships thereof.

### Advantageous Effects

Since <a computing module capable of checking a change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units or a change situation (for example, various index and indicator situations, news situations, external event occurrence situations or the like) of an IP-belonged financial market>, <a computing module capable of comparing the checked change situation of the customer-possessing IP or the checked change situation of the IP-belonged financial market with IM rebalancing distribution channel setting information, previously stored, and determining whether the corresponding change situation corresponds to an opportunity situation where the IM needs to be rebalanced>, <a computing module capable of, in case the change situation of the customer-possessing IP or the change situation of the IP-belonged financial market corresponds to an opportunity situation where the IM needs to be rebalanced, generating IM rebalancing execution information for the plurality of customer-possessing units according to the IM rebalancing distribution channel setting information and transmitting the generated IM rebalancing execution information to the IM managing backbone server so that a set of IM rebalancing executing procedures is performed to the plurality of customer-possessing units under complex relationships thereof> or the like are systematically disposed and associated in a communication pipeline of an IM managing backbone server of the present disclosure, under a circumstance where the present disclosure is implemented, when a set of IM rebalancing opportunity situations occur, the plurality of customer-possessing units may be guided to be rebalanced according to a preset quantity, amount or importance while forming a set of IM rebalancing distribution channel networks (or, investment product rebalancing distribution channel network) where the units are densely connected each other like a mesh according to a set of preset serial rebalancing distribution channels or chainlike rebalancing distribution channels, instead of automatic simple ordering, so that a customer or IM management company (for example, a stock trading company or the like) may be guided not to simplify but to diversify rebalancing paths of investment products (hereinafter, referred to as “IP”) or IP portfolio into various patterns and therefore effectively enjoy resultant economic benefits.

### DESCRIPTION OF DRAWINGS

FIG. 1 is a schematic view exemplarily showing a general procedure for rebalancing an IM or IP.

FIG. 2 is a schematic view exemplarily showing a procedure for rebalancing an IM or IP according to the present disclosure.

FIG. 3 is a schematic view exemplarily showing a pattern of IM rebalancing path networks (or, a pattern of IP rebalancing path networks) among a plurality of customer-possessing units according to the present disclosure.

FIG. 4 is a schematic view exemplarily showing a detailed configuration of an IM distribution channel managing system according to the present disclosure.

FIG. 5 is a schematic view exemplarily showing function executing procedures of a guide frame managing module and an IM rebalancing projected path template providing module according to the present disclosure.

FIG. 6 is a schematic view exemplarily showing function executing procedures of an IP/market change situation checking module, an IM rebalancing opportunity occurrence determining module, and an IM rebalancing execution information generating module according to the present disclosure.

FIG. 7 is a schematic view exemplarily showing function executing procedures of an IM rebalancing execution notifying module and an IM rebalancing result notifying module according to the present disclosure.

FIG. 8 is a schematic view exemplarily showing function executing procedures of an IM rebalancing resetting supporting module and an IM rebalancing projected path template providing module according to the present disclosure.

FIG. 9 is a schematic view exemplarily showing a pattern of IM rebalancing path networks (or, a pattern of IP rebalancing path networks) among a plurality of customer-possessing units according to another embodiment of the present disclosure.

### BEST MODE

Hereinafter, an IM distribution channel managing system according to the present disclosure will be described in detail with reference to the accompanying drawings.

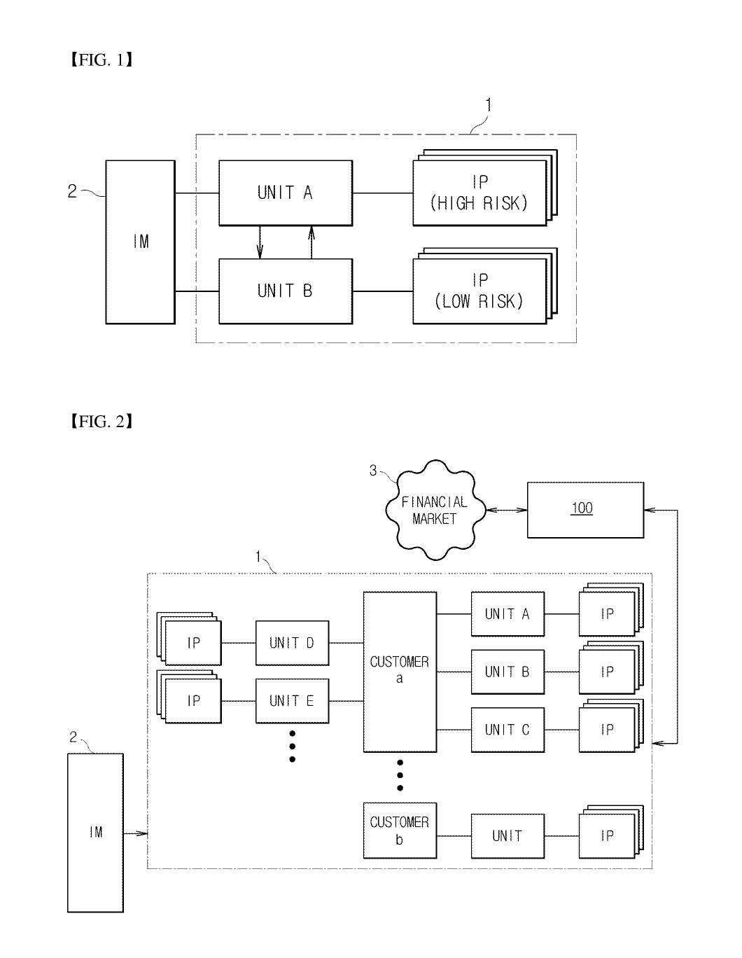

As shown in FIG. 2, under the system of the present disclosure, an IM managing backbone server 1 for general computerized investment/management of a customer IM 2 uses a plurality of customer-possessing units (for example, a unit A, a unit B, a unit C, a unit D, a unit E or the like possessed by a customer a) (here, the unit represents a financial product management unit such as <bank account>, <account>, <virtual account>, <unified managed account (UMA)> or the like) connected to various investment products (IPs) to invest the customer IM 2 in IPs such as <corporate bond with a low credit rating>, <stock>, <capital unprotected equity linked securities (ELS)>, <stock fund seeking a profit in a market return level>, <stock fund seeking a profit over a market return level>, <derivative product>, <investment fund>, <credit stock trading>, <equity linked warrant (ELW)>, <futures/options>, <money market fund (MMF)>, <repurchase paper>, <cash management account (CMA)>, <national bond>, <local bond>, <guaranteed bond>, <bank debenture>, <corporate bond with a high credit rating>, <bond fund>, <capital guarantee ELS> or the like.

At this time, different from the general case, the present disclosure devises additional installation of a specific IM distribution channel managing system 100 in a communication pipeline of the IM managing backbone server 1 (in this case, the IM distribution channel managing system 100 of the present disclosure may form a structure subordinately installed in a program block of the IM managing backbone server 1).

In this circumstance, the IM distribution channel managing system 100 of the present disclosure checks a change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units (for example, a unit A, a unit B, a unit C, a unit D, a unit E or the like possessed by a customer a) or a change situation (for example, various index and indicator situations, news situations, external event occurrence situations or the like) of an IP-belonged financial market. In case in case the checked change situation of the customer-possessing IP or the checked change situation of the IP-belonged financial market corresponds to a set of opportunity situations where the IM needs to be rebalanced (for example, a situation where an XX IP connected to the unit A reaches a target figure, a situation where a stock price of an XX IP belonging to the unit C touches a preset lower limit (or upper limit), a situation where a stock price of an XX IP connected to the unit D and a stock price of an XX IP connected to the unit E are different from each other by a predetermined %, a situation where an XX index reaches an XXX point, a situation where a news informing that an XX oil price rises over an XX dollar is publicly announced, or the like) (such opportunity situations may change in various ways according to circumstances or customer's setting details), the IM distribution channel managing system 100 of the present disclosure communicates with the IM managing backbone server 1 and supports so that a set of IM rebalancing executing procedures to be <executed under complex relationships with respect to a plurality of units possessed by the customer (for example, the unit A, the unit B, the unit C, the unit D, the unit E or the like possessed by the customer a)>.

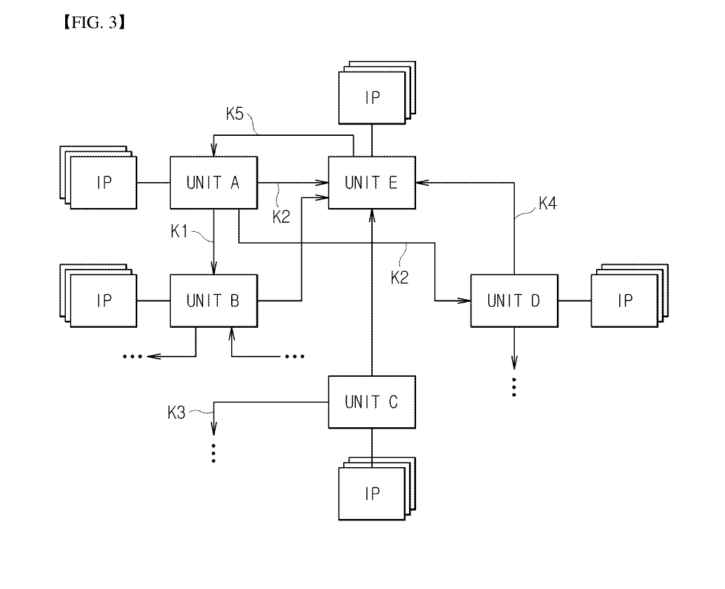

In this circumstance, as shown in FIG. 3, when a set of IM rebalancing opportunity situations (for example, a situation where an XX IP connected to the unit A reaches a target figure, a situation where a stock price of an XX IP belonging to the unit C touches a preset lower limit (or upper limit), a situation where a stock price of an XX IP connected to the unit D and a stock price of an XX IP connected to the unit E are different from each other by a predetermined %, a situation where an XX index reaches an XXX point, a situation where a news informing that an XX oil price rises over an XX dollar is publicly announced, or the like) occur, the plurality of units possessed by the customer (for example, the unit A, the unit B, the unit C, the unit D, the unit E or the like possessed by the customer a) may be guided to be rebalanced according to a preset quantity, amount or importance while forming a set of IM rebalancing distribution channel networks (or, investment product rebalancing distribution channel networks) (K1, K2, K3, K4, K5 or the like) where the units are densely connected each other like a mesh according to a set of preset serial rebalancing distribution channels or chainlike rebalancing distribution channels, instead of automatic simple ordering, so that the customer or IM management company (for example, a stock trading company or the like) may diversify rebalancing paths of the IP or IP portfolio into various patterns and therefore effectively enjoy resultant economic benefits.

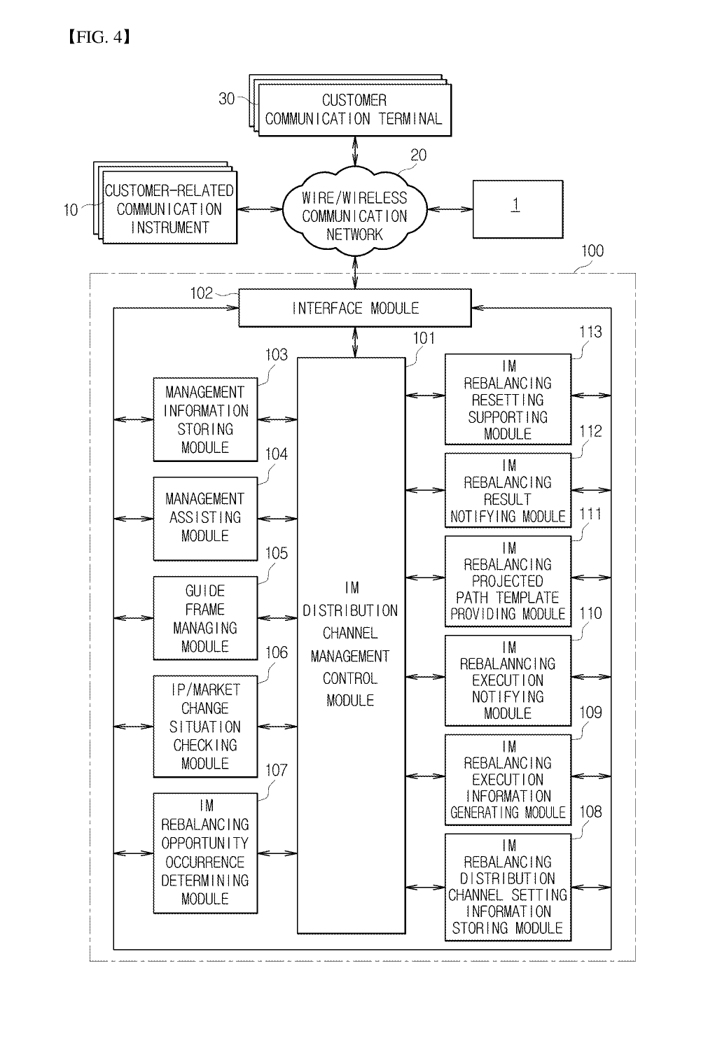

At this time, as shown in FIG. 4, in the IM distribution channel managing system 100 according to the present disclosure, a customer-related communication instrument 10 (for example, a communication instrument directly used by a customer, a communication instrument of an IM management company where a customer visits, or the like) (for example, a PC, a mobile communication instrument or the like), a customer communication terminal 30 (for example, an electronic mail sending/receiving account, a mobile communication instrument, a short message service sending/receiving account, a social network message sending/receiving account or the like, possessed by a customer (or, managed by a customer)), and an IM distribution channel management control module 101 for controlling/assisting the overall IM managing procedure while communicating with the IM managing backbone server 1 as well as a management information storing module 103, a management assisting module 104, a guide frame managing module 105, an IP/market change situation checking module 106, an IM rebalancing opportunity occurrence determining module 107, an IM rebalancing distribution channel setting information storing module 108, an IM rebalancing execution information generating module 109, an IM rebalancing execution notifying module 110, an IM rebalancing projected path template providing module 111, an IM rebalancing result notifying module 112, an IM rebalancing resetting supporting module 113 or the like, controlled by the IM distribution channel management control module 101, are closely associated by means of a wire/wireless communication network 20 (for example, a wire/wireless Internet network, a wire/wireless financial communication network or the like) and an interface module 102.

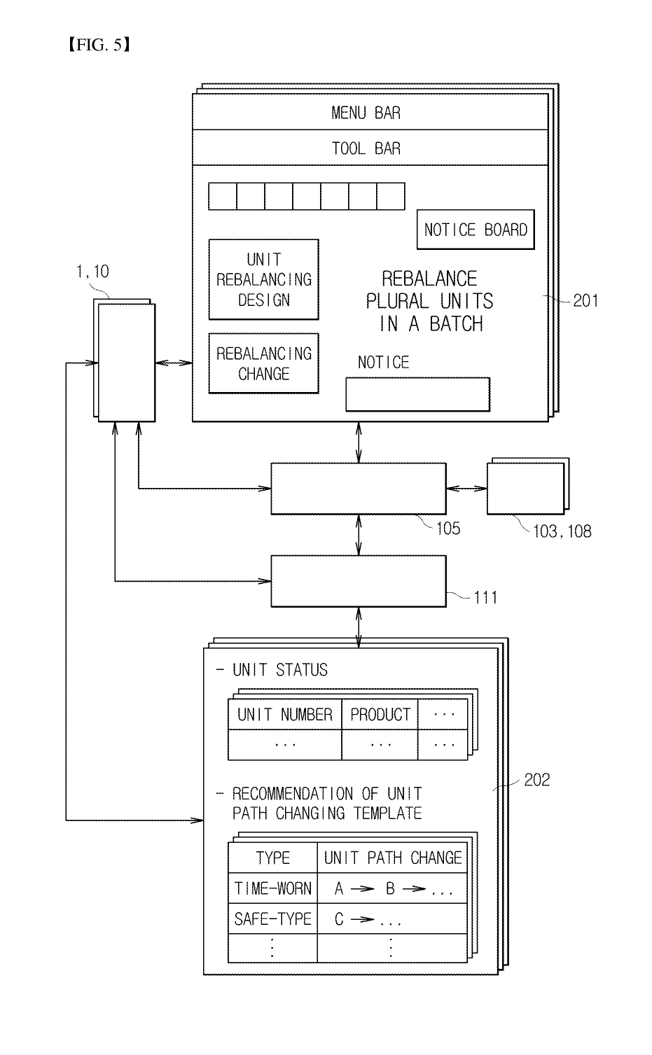

Here, the management information storing module 103 plays a role of stably storing and managing various kinds of management information required for the IM distribution channel managing service, for example registration information of the customer, registration information of the IM managing backbone server 1, resource status information of the system 100, component information required for executing a computing process of each computing module in the system 100, text information/graphic information/setting information for generating a guide frame 201 (see FIG. 5) or the like, in its information storage area (the item or range of each information listed above may be elastically added, deleted or changed according to the circumstance of the system 100).

In addition, the management assisting module 104 performs various auxiliary management procedure required for the IM distribution channel management service, for example a procedure of managing a system logging-in process of a customer, a procedure of establishing/maintaining a communication session with exterior computing devices 1, 10, 30, a procedure of updating/managing the management information or the like, in various ways.

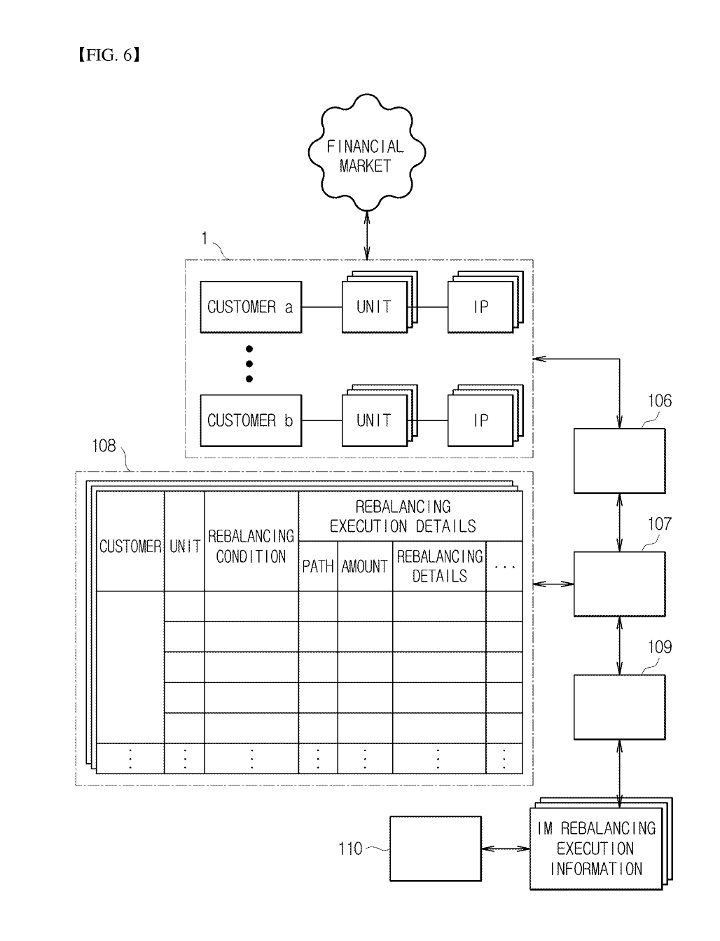

Moreover, the IM rebalancing distribution channel setting information storing module 108 plays a role of storing and managing <various setting information associated with IM rebalancing (namely, rebalancing condition information/rebalancing target/quantity/amount/importance execution details information or the like of each unit)> set by the customer, for example setting information such as <in case an XX IP connected to the unit A reaches a target figure, sell the XX IP of the unit A and buy the XX IP of the unit B, and additionally buy the XX IP of the unit D, . . . >, setting information such as <in case the stock price of the XX IP belonging to the unit C touches a preset lower limit (or, upper limit), sell the XX IP of the unit C and buy the XX IP of the unit B, and additionally buy the XX IP of the unit D, . . . >, setting information such as <in case a stock price of the XX IP connected to the unit D and a stock price of the XX IP connected to the unit E are different from each other by a predetermined %, sell the XX IP of the unit D and buy the XX IP of the unit A, and additionally buy the XX IP of the unit C, . . . >, setting information such as <in case the XX index reaches an XXX point, sell the XX IP of the unit A and buy the XX IP of the unit C, and additionally buy the XX IP of the unit D, . . . >, setting information such as <in case a news informing that an XX oil price rises over an XX dollar is publicly announced, sell the XX IP of the unit C and buy the XX IP of the unit A, and additionally buy the XX IP of the unit D, . . . >, or the like (see FIG. 6).

At this time, as shown in FIG. 5, in case the customer logs in the system 100 through the customer-related communication instrument 10, the guide frame managing module 105 controlled by the IM distribution channel management control module 101 communicates with the management information storing module 103, extracts text information/graphic information/setting information or the like for generating a guide frame 201, generates a guide frame 201 by utilizing the extracted text information/graphic information/setting information or the like, transmits the generated guide frame 300 to the IM managing backbone server 1, and supports so that the corresponding guide frame 300 may be output and notified via the wire/wireless communication network 20 through the customer-related communication instrument 10 which is in access to the IM managing backbone server 1 (the output path of the guide frame may be modified in various ways according to the circumstances).

In the state where the guide frame 201 is output and notified, the customer may freely set various kinds of setting information (namely, rebalancing condition/execution detail information of each unit) associated with rebalancing of the IM by just a simple computing procedure of selecting one of various menus displayed at the corresponding guide frame 201.

At this time, the IM rebalancing projected path template providing module 111 controlled by the IM distribution channel management control module 101, for example, communicates with the customer-related communication instrument 10 through the IM managing backbone server 1, and in case various kinds of setting information associated with rebalancing of the IM is being set by the customer, the IM rebalancing projected path template providing module 111 plays a role of generating an IM rebalancing projected path template 202 where a rebalancing projected path of the IM is displayed as a connection relation of the plurality of customer-possessing units (for example, the unit A, the unit B, the unit C, the unit D, the unit E or the like possessed by the customer a), and providing the generated IM rebalancing projected path template 202 to the IM managing backbone server 1.

In a circumstance where the IM rebalancing projected path template providing module 111 performs the above function, a customer who accesses the IM managing backbone server 1 through the customer-related communication instrument 10 may effectively refer to the corresponding IM rebalancing projected path template 202 when setting the IM rebalancing distribution channel setting information. As a result, without any difficulty, the user may easily set an IM rebalancing path suitable for the customer's type (for example, a time-worn IM rebalancing path, a safe-type IM rebalancing path, an attacking-type IM rebalancing path or the like).

In a circumstance where the aforementioned infrastructure is prepared, as shown in FIG. 6, the IP/market change situation checking module 106 controlled by the IM distribution channel management control module 101 communicates with the IM managing backbone server 1 through the interface module 102, checks a change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units (for example, the unit A, the unit B, the unit C, the unit D, the unit E or the like possessed by the customer a) or a change situation (for example, various index and indicator situations, news situations, external event occurrence situations or the like) of an IP-belonged financial market, and obtains the corresponding checking result, thereby establishing a basic environment where the IM distribution channel managing procedure according to the present disclosure may be performed normally.

By doing so, in a circumstance where the change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units (for example, the unit A, the unit B, the unit C, the unit D, the unit E or the like possessed by the customer a) or the change situation (for example, various index and indicator situations, news situations, external event occurrence situations or the like) of an IP-belonged financial market is checked and inspected, as shown in FIG. 6, the IM rebalancing opportunity occurrence determining module 107 controlled by the IM distribution channel management control module 101 firstly communicates with the IP/market change situation checking module 106 and performs a procedure for figuring out the change situation of the customer-possessing IP or the change situation of the IP-belonged financial market.

Through this procedure, if the change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units (for example, the unit A, the unit B, the unit C, the unit D, the unit E or the like possessed by the customer a) or the change situation (for example, various index and indicator situations, news situations, external event occurrence situations or the like) of an IP-belonged financial market is completely figured out, the IM rebalancing opportunity occurrence determining module 107 communicates with the IM rebalancing distribution channel setting information storing module 108, compares the checked change situation of the customer-possessing IP and the checked change situation of the IP-belonged financial market with IM rebalancing distribution channel setting information, previously stored, and therefore determines whether the corresponding change situation corresponds to opportunity situations where the IM needs to be rebalanced (for example a situation where an XX IP connected to the unit A reaches a target figure, a situation where a stock price of an XX IP belonging to the unit C touches a preset lower limit (or upper limit), a situation where a stock price of an XX IP connected to the unit D and a stock price of an XX IP connected to the unit E are different from each other by a predetermined %, a situation where an XX index reaches an XXX point, a situation where a news informing that an XX oil price rises over an XX dollar is publicly announced, or the like) (see FIG. 6).

At this time, if it is determined that the change situation (for example, a target figure reaching situation of an IP connected to each unit, a lower limit (or upper limit) touch situation of an IP connected to each unit, a stock price situation of an IP connected to each unit or the like) of an IP connected to a plurality of customer-possessing units (for example, the unit A, the unit B, the unit C, the unit D, the unit E or the like possessed by the customer a) or the change situation (for example, various index and indicator situations, news situations, external event occurrence situations or the like) of an IP-belonged financial market corresponds to opportunity situations where the IM needs to be rebalanced (for example, a situation where an XX IP connected to the unit A reaches a target figure, a situation where a stock price of an XX IP belonging to the unit C touches a preset lower limit (or upper limit), a situation where a stock price of an XX IP connected to the unit D and a stock price of an XX IP connected to the unit E are different from each other by a predetermined %, a situation where an XX index reaches an XXX point, a situation where a news informing that an XX oil price rises over an XX dollar is publicly announced, or the like), the IM rebalancing opportunity occurrence determining module 107 instantly carries on a data generating routine to generate a message, for example <generate IM rebalancing execution information since a situation where the IM needs to be rebalanced occurs>, and then transmits the generated message to the IM rebalancing execution information generating module 109 (a plurality of IM rebalancing opportunity situations may occur simultaneously depending on circumstances).

By doing so, if a message about a situation where the IM needs to be balanced is transmitted, as shown in FIG. 6, the IM rebalancing execution information generating module 109 controlled by the IM distribution channel management control module 101 communicates with the IM rebalancing distribution channel setting information storing module 108, reads the IM rebalancing distribution channel setting information stored therein (for example, setting information such as <in case an XX IP connected to the unit A reaches a target figure, sell the XX IP of the unit A and buy the XX IP of the unit B, and additionally buy the XX IP of the unit D, . . . >, setting information such as <in case the stock price of the XX IP belonging to the unit C touches a preset lower limit (or, upper limit), sell the XX IP of the unit C and buy the XX IP of the unit B, and additionally buy the XX IP of the unit D, . . . >, setting information such as <in case a stock price of the XX IP connected to the unit D and a stock price of the XX IP connected to the unit E are different from each other by a predetermined %, sell the XX IP of the unit D and buy the XX IP of the unit A, and additionally buy the XX IP of the unit C, . . . >, setting information such as <in case the XX index reaches an XXX point, sell the XX IP of the unit A and buy the XX IP of the unit C, and additionally buy the XX IP of the unit D, . . . >, setting information such as <in case a news informing that an XX oil price rises over an XX dollar is publicly announced, sell the XX IP of the unit C and buy the XX IP of the unit A, and additionally buy the XX IP of the unit D, . . . >, or the like), and then carries on a set of data generating routines according to the read contents, thereby generating a set of IM rebalancing execution information with respect to the plurality of customer-possessing units (for example, the unit A, the unit B, the unit C, the unit D, the unit E or the like possessed by the customer a).

At this time, in case <the opportunity situation where the IM needs to be rebalanced> mentioned above corresponds to <a situation where an XX IP connected to the unit A reaches a target figure>, the IM rebalancing execution information contains execution details such as <sell the XX IP of the unit A and buy the XX IP of the unit B, and additionally buy the XX IP of the unit D, . . . > according to the IM rebalancing distribution channel setting information.

In addition, in case <the opportunity situation where the IM needs to be rebalanced> corresponds to, for example, <the stock price of the XX IP belonging to the unit C touches a preset lower limit (or, upper limit)>, the IM rebalancing execution information contains execution details such as <sell the XX IP of the unit C and buy the XX IP of the unit B, and additionally buy the XX IP of the unit D, . . . > according to the IM rebalancing distribution channel setting information.

Moreover, in case <the opportunity situation where the IM needs to be rebalanced> corresponds to, for example, <a stock price of the XX IP connected to the unit D and a stock price of the XX IP connected to the unit E are different from each other by a predetermined %>, the IM rebalancing execution information contains execution details such as <sell the XX IP of the unit D and buy the XX IP of the unit A, and additionally buy the XX IP of the unit C, . . . > according to the IM rebalancing distribution channel setting information.

In addition, in case <the opportunity situation where the IM needs to be rebalanced> corresponds to, for example, <the XX index reaches an XXX point>, the IM rebalancing execution information contains execution details such as <sell the XX IP of the unit A and buy the XX IP of the unit C, and additionally buy the XX IP of the unit D, . . . > according to the IM rebalancing distribution channel setting information.

Further, in case <the opportunity situation where the IM needs to be rebalanced> corresponds to, for example, <a news informing that an XX oil price rises over an XX dollar is publicly announced>, the IM rebalancing execution information contains execution details such as <sell the XX IP of the unit C and buy the XX IP of the unit A, and additionally buy the XX IP of the unit D, . . . > according to the IM rebalancing distribution channel setting information.

By doing so, if a set of IM rebalancing execution information with respect to the plurality of customer-possessing units (for example, the unit A, the unit B, the unit C, the unit D, the unit E or the like possessed by the customer a) is generated, the IM rebalancing execution information generating module 109 transmits the generated IM rebalancing execution information to the IM rebalancing notifying module 110, thereby assisting so that a set of IM rebalancing execution details may be actually performed by the IM managing backbone server 1 (see FIG. 6).

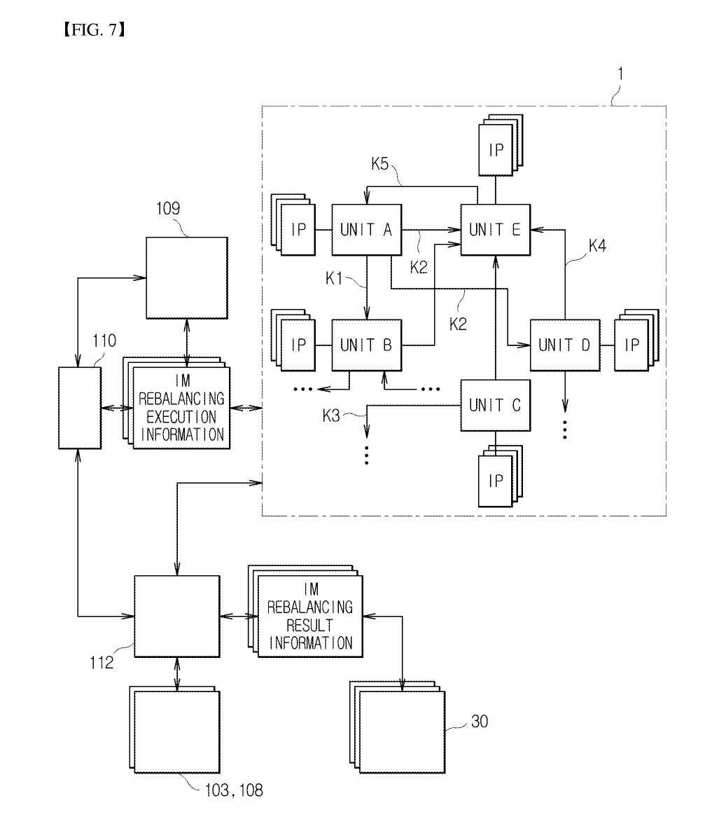

Through the above procedure, if a set of IM rebalancing execution information with respect to the plurality of customer-possessing units (for example, the unit A, the unit B, the unit C, the unit D, the unit E or the like possessed by the customer a) is transmitted, as shown in FIG. 7, the IM rebalancing execution notifying module 110 controlled by the IM distribution channel management control module 101 communicates with the IM rebalancing execution information generating module 109 to receive the information, and then communicates with the IM managing backbone server 1 through the interface module 102 to transmit the received IM rebalancing execution information to the IM managing backbone server 1. As a result, the plurality of customer-possessing units (for example, the unit A, the unit B, the unit C, the unit D, the unit E or the like possessed by the customer a) computer-managed by the IM managing backbone server 1 may effectively experience a set of IM rebalancing executing procedures under complex relationships thereof.

As described above, since <a computing module capable of checking a change situation (for example, a target figure reaching situation of an IP associated with each unit, a lower limit (or upper limit) touch situation of an IP associated with each unit, a stock price situation of an IP associated with each unit or the like) of an IP associated with a plurality of customer-possessing units or a change situation (for example, various index and indicator situations, news situations, external event occurrence situations or the like) of an IP-belonged financial market>, <a computing module capable of comparing the checked change situation of the customer-possessing IP or the checked change situation of the IP-belonged financial market with IM rebalancing distribution channel setting information, previously stored, and determining whether the corresponding change situation corresponds to an opportunity situation where the IM needs to be rebalanced>, <a computing module capable of, in case the change situation of the customer-possessing IP or the change situation of the IP-belonged financial market corresponds to an opportunity situation where the IM needs to be rebalanced, generating IM rebalancing execution information for the plurality of customer-possessing units according to the IM rebalancing distribution channel setting information and transmitting the generated IM rebalancing execution information to the IM managing backbone server so that a set of IM rebalancing executing procedures is performed to the plurality of customer-possessing units under complex relationships thereof> or the like are systematically disposed in the present disclosure, under a circumstance where the present disclosure is implemented, if a set of IM rebalancing opportunity situations occurs, the plurality of customer-possessing units may be guided to be rebalanced according to a preset quantity, amount or importance while forming a set of IM rebalancing distribution channel networks (or, investment product rebalancing distribution channel networks) (K1, K2, K3, K4, K5 or the like) where the units are densely connected each other like a mesh according to a set of preset serial rebalancing distribution channels or chainlike rebalancing distribution channels, instead of automatic simple ordering, so that the customer or IM management company (for example, a stock trading company or the like) may diversify rebalancing paths of the IP or IP portfolio into various patterns and therefore effectively enjoy resultant economic benefits.

Meanwhile, as described above, under the system of the present disclosure, a plurality of IM rebalancing opportunity situations of the customer-possessed units may occur together (for example, simultaneously or within a predetermined unit time) (for example, simultaneously occurring at the unit A, the unit C, the unit E, . . . ).

In such a sensitive circumstance, the IM rebalancing execution information generating module 109 of the present disclosure communicates with the IM rebalancing distribution channel setting information storing module 108, refers to the IM rebalancing distribution channel setting information, previously stored, then generates priority-processing IM rebalancing execution information according to rebalancing priority processing setting details defined therein (for example, in case IM rebalancing opportunity situations simultaneously occurs in the unit A, the unit C, and the unit E, rebalancing associated with the unit C is processed first, then rebalancing associated with the unit E is processed, then . . . ), and transmits the generated priority-processing IM rebalancing execution information to the IM rebalancing execution notifying module 110.

In this circumstance, the unit A, the unit C, the unit E . . . may normally experience IM rebalancing procedures in order without any difficulty even though a set of IM rebalancing opportunity situations occurs simultaneously.

As another example, in case IM rebalancing opportunity situations occur simultaneously in the unit A, the unit C, and the unit E, possessed by the customer, the IM rebalancing execution information generating module 109 of the present disclosure communicates with the IM rebalancing distribution channel setting information storing module 108, refers to IM rebalancing distribution channel setting information stored therein, then generates a set of netting-processing IM rebalancing execution information according to rebalancing netting-processing setting details defined therein (for example, in case IM rebalancing opportunity situations simultaneously occurs in the unit A, the unit C, and the unit E, selling/buying orders under setoff relationship among selling/buying orders associated with the unit A, the unit C, and the unit E are set off with each other for 1 day and then set, and they are rebalanced at once according to the net transaction details . . . ), and transmits the generated netting-processing IM rebalancing execution information to the IM rebalancing execution notifying module 110.

In this circumstance, the unit A, the unit C, the unit E . . . may normally experience netting-type IM rebalancing procedures in order without any difficulty even though a set of IM rebalancing opportunity situations occurs simultaneously.

Meanwhile, as shown in FIG. 4, an IM rebalancing result notifying module 112, an IM rebalancing resetting supporting module 113 or the like is additionally disposed under the control of the IM distribution channel management control module 101, in addition to various computing modules described above.

At this time, as shown in FIG. 7, the IM rebalancing result notifying module 112 controlled by the IM distribution channel management control module 101 communicates with the IM managing backbone server 1 through the interface module 102, and if the IM rebalancing executing procedure described above is completed, instantly carries on a set of data generating routines to generate IM rebalancing execution result information where the corresponding IM rebalancing executing procedure is reflected, and transmits the generated IM rebalancing execution result information to the customer communication terminal 30 managed by the customer (for example, an electronic mail sending/receiving account, a mobile communication instrument, a short message service sending/receiving account, a social network message sending/receiving account or the like) (in this case, the IM execution result information may be transmitted to the customer communication terminal 30 via the IM managing backbone server 1).

If the IM rebalancing result notifying module 112 functions as described above, the customer may check the rebalancing situation of his IM in real time and therefore effectively enjoy various resultant benefits.

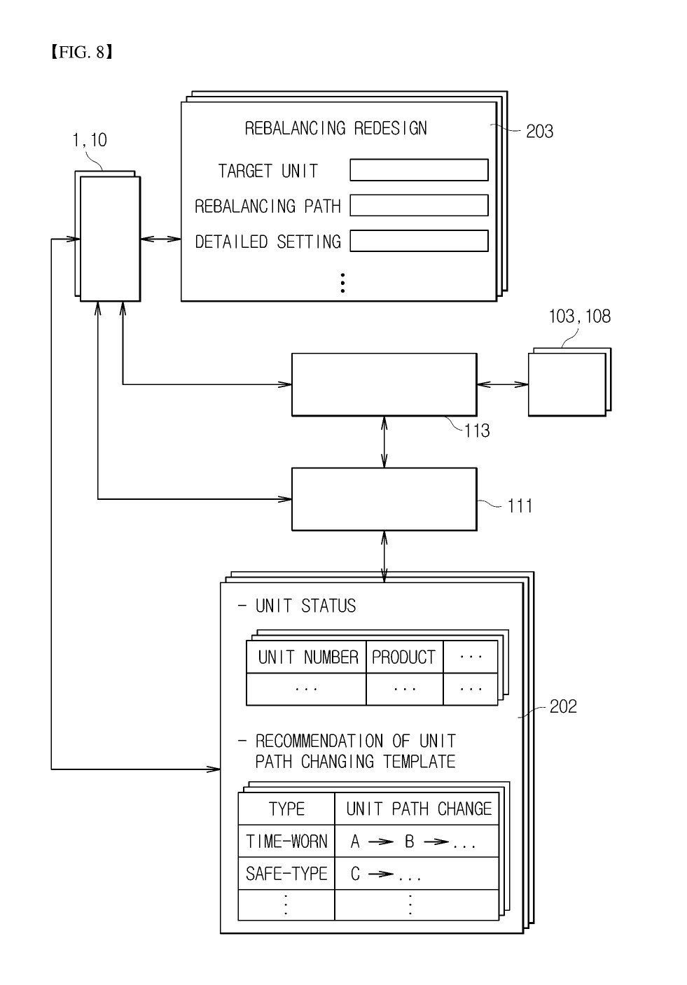

In addition, as shown in FIG. 8, the IM rebalancing resetting supporting module 113 controlled by the IM distribution channel management control module 101 communicates with the customer-related communication instrument 10 through the IM managing backbone server 1, and at the request of a customer, generates a guide frame 203 associated with additional rebalancing setting of the IM, and transmits the generated guide frame 203 to the IM managing backbone server 1, thereby supporting so that the customer accessing the IM managing backbone server 1 through the customer-related communication instrument 10 may freely add or change preset IM rebalancing distribution channel setting information as desires.

In this circumstance, the IM rebalancing projected path template providing module 111 controlled by the IM distribution channel management control module 101 communicates with the IM managing backbone server 1, and if various kinds of setting information associated with IM rebalancing are being reset by the customer, generates the IM rebalancing projected path template 202 where a rebalancing projected path of the IM is displayed as a connection relation of the plurality of customer-possessing units (for example, the unit A, the unit B, the unit C, the unit D, the unit E or the like possessed by the customer a), and provides the generated IM rebalancing projected path template 202 to the IM managing backbone server 1.

If the IM rebalancing projected path template providing module 111 functions as above, the customer accessing the IM managing backbone server 1 through the customer-related communication instrument 10 may effectively refer to the corresponding IM rebalancing projected path template 202 when resetting the IM rebalancing distribution channel setting information, and easily set an IM rebalancing path suitable for the customer's type (for example, a time-worn IM rebalancing path, a safe-type IM rebalancing path, an attacking-type IM rebalancing path or the like) without any difficulty.

The present disclosure may be modified in various ways according to circumstances.

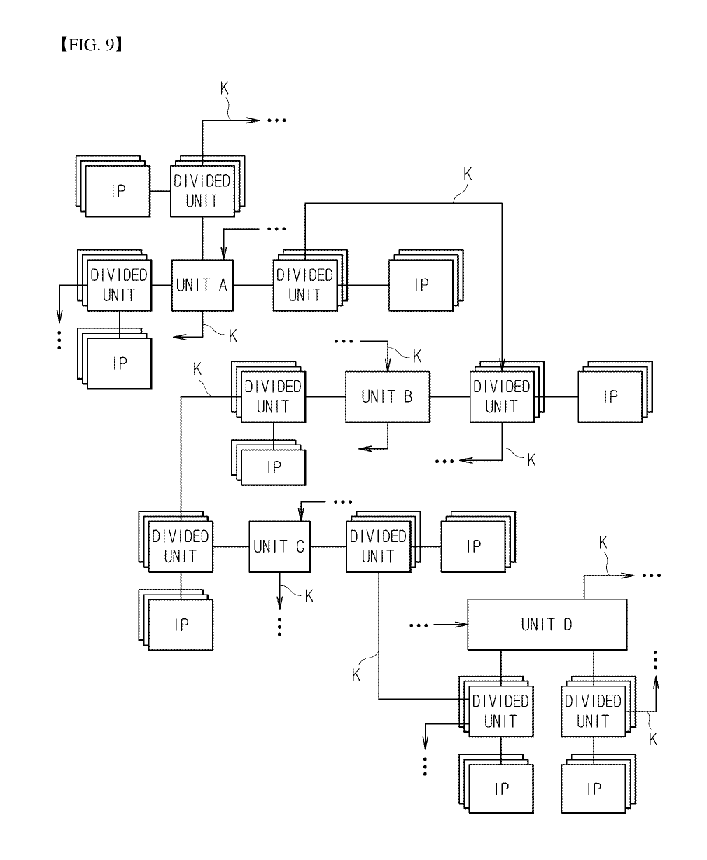

For example, in the present disclosure, as shown in FIG. 9, a plurality of divided units (for example, a divided unit dedicated to a short-term withdrawal schedule, a divided account dedicated to a middle-term withdrawal schedule, a divided unit dedicated to a long-term withdrawal schedule, or the like) for managing deposit or withdrawal of the IM in a state of being connected to a part or all of the plurality of customer-possessing units (for example, the unit A, the unit B, the unit C, the unit D, the unit E or the like possessed by the customer a) may be additionally established.

Under a circumstance where such a divided unit is additionally established, in case a set of IM rebalancing executing procedures is carried on, a plurality of parent units (for example, the unit A, the unit B, the unit C, the unit D, the unit E or the like) and the divided units may form a set of IM rebalancing distribution channel networks (or, IP rebalancing distribution channel network) K where the units are densely connected like a mesh between them (for example, between the parent unit and the parent unit, between the parent unit and the divided unit, between the divided unit and the divided unit or the like). As a result, the customer or IM management company (for example, a stock trading company or the like) may diversify rebalancing paths of the IP or IP portfolio into various patterns and therefore effectively enjoy resultant economic benefits.

The present disclosure is not limited to a specific field and generally gives useful effects in various fields where investment money or investment products should be managed.

In addition, even though a specific embodiment of the present disclosure has been described and illustrated, it is obvious that the present disclosure can be modified in various ways by those skilled in the art.

Such modifications should not be understood separate from the technical spirit or viewpoint of the present disclosure but be regarded as being included in the scope of the appended claims.

### INDUSTRIAL APPLICABILITY

According to the system and method for managing a distribution channel of investment money as described above, when a set of IM rebalancing opportunity situations occurs, a plurality of customer-possessing units may be guided to be rebalanced according to a preset quantity, amount or importance while forming a set of IM rebalancing distribution channel networks where the units are densely connected like a mesh according to a set of preset serial rebalancing distribution channels or chainlike rebalancing distribution channels, instead of automatic simple ordering. As a result, a customer or IM management company may diversify rebalancing paths of an IP or IP portfolio into various patterns and therefore effectively enjoy resultant economic benefits.

1. A system for managing a distribution channel of investment money (IM), comprising:
an IM distribution channel management control module for communicating with an IM managing backbone server, which performs computerized management for a process of investing investment money (IM) of a customer to investment products (IP), storing IM rebalancing distribution channel setting information associated with rebalancing of the IM, and controlling a managing procedure of the IM, by means of a plurality of customer-possessing units;
an IP/market change situation checking module controlled by the IM distribution channel management control module to communicate with the IM managing backbone server and check a change situation of an IP connected to the plurality of customer-possessing units or a change situation of an IP-belonged financial market which the IP belongs to;
an IM rebalancing opportunity occurrence determining module controlled by the IM distribution channel management control module to communicate with the IP/market change situation checking module, check a change situation of an customer-possessing IP or a change situation of the IP-belonged financial market, then compare the checked change situation of the customer-possessing IP or the checked change situation of the IP-belonged financial market with the IM rebalancing distribution channel setting information, previously stored, and determine whether the corresponding change situation corresponds to an opportunity situation where the IM needs to be rebalanced;
an IM rebalancing execution information generating module controlled by the IM distribution channel management control module, wherein in case the change situation of the customer-possessing IP or the change situation of the IP-belonged financial market corresponds to an opportunity situation where the IM needs to be rebalanced, the IM rebalancing execution information generating module generates IM rebalancing execution information for the plurality of customer-possessing units according to the IM rebalancing distribution channel setting information; and
an IM rebalancing execution notifying module controlled by the IM distribution channel management control module to transmit the IM rebalancing execution information to the IM managing backbone server so that an IM rebalancing executing procedure is performed to the plurality of customer-possessing units, subject to computerized management of the IM managing backbone server, under complex relationships thereof.

2. The system for managing a distribution channel of IM according to claim 1, wherein for a part or all of the plurality of customer-possessing units, a plurality of divided units connected to the corresponding units and managing deposit or withdrawal of the IM is additionally established.

3. The system for managing a distribution channel of IM according to claim 1, further comprising an IM rebalancing result notifying module controlled by the IM distribution channel management control module to communicate with the IM managing backbone server, generate IM rebalancing execution result information where the IM rebalancing executing procedure is reflected, and transmit the generated IM rebalancing execution result information to a customer communication terminal managed by the customer so that a rebalancing situation of the IM is checked in real time by the customer.

4. The system for managing a distribution channel of IM according to claim 1, further comprising an IM rebalancing resetting supporting module controlled by the IM distribution channel management control module to generate a guide frame associated with an additional rebalancing setting of the IM, and transmit the generated guide frame to the IM managing backbone server so that the IM rebalancing distribution channel setting information is reset by addition or change of the customer.

5. The system for managing a distribution channel of IM according to claim 1, further comprising an IM rebalancing projected path template providing module controlled by the IM distribution channel management control module to communicate with the IM managing backbone server, wherein in case the IM rebalancing distribution channel setting information is being set or reset by the customer, the IM rebalancing projected path template providing module generates an IM rebalancing projected path template where a rebalancing projected path of the IM is displayed as a connection relation of the plurality of customer-possessing units, and provides the generated IM rebalancing projected path template to the IM managing backbone server so that the corresponding IM rebalancing projected path template is referred to when the IM rebalancing distribution channel setting information is set or reset by the customer.

6. The system for managing a distribution channel of IM according to claim 1, wherein in case opportunity situations needing to be rebalanced simultaneously occur at the plurality of customer-possessing units within a unit time, the IM rebalancing execution information generating module generates priority-processing IM rebalancing execution information or netting-processing IM rebalancing execution information according to rebalancing priority processing setting details or rebalancing netting-processing setting details defined in the IM rebalancing distribution channel setting information, and transmits the generated priority-processing IM rebalancing execution information or netting-processing IM rebalancing execution information to the IM rebalancing execution notifying module.

7. A method for managing a distribution channel of IM, comprising:
communicating with an IM managing backbone server, which performs computerized management for a process of investing investment money (IM) of a customer to investment products (IP) to check a change situation of a customer-possessing IP connected to the plurality of customer-possessing units or a change situation of an IP-belonged financial market which the IP belongs to;
comparing the checked change situation of the customer-possessing IP or the checked change situation of the IP-belonged financial market with <IM rebalancing distribution channel setting information, previously stored, associated with rebalancing of the IM> and determining whether the corresponding change situation corresponds to an opportunity situation where the IM needs to be rebalanced;
generating IM rebalancing execution information for the plurality of customer-possessing units according to the IM rebalancing distribution channel setting information in case the change situation of the customer-possessing IP or the change situation of the IP-belonged financial market corresponds to an opportunity situation where the IM needs to be rebalanced; and
transmitting the IM rebalancing execution information to the IM managing backbone server so that an IM rebalancing executing procedure is performed to the plurality of customer-possessing units, subject to computerized management of the IM managing backbone server, under complex relationships thereof.

8. The method for managing a distribution channel of IM according to claim 7, further comprising:
communicating with the IM managing backbone server, generating IM rebalancing execution result information where the IM rebalancing executing procedure is reflected, and transmitting the generated IM rebalancing execution result information to a customer communication terminal managed by the customer so that a rebalancing situation of the IM is checked in real time by the customer.

9. The method for managing a distribution channel of IM according to claim 7, further comprising:
generating a guide frame associated with an additional rebalancing setting of the IM, and transmitting the generated guide frame to the IM managing backbone server so that the IM rebalancing distribution channel setting information is reset by addition or change of the customer.

10. The method for managing a distribution channel of IM according to claim 7, further comprising:
communicating with the IM managing backbone server, and in case the IM rebalancing distribution channel setting information is being set or reset by the customer, generating an IM rebalancing projected path template where a rebalancing projected path of the IM is displayed as a connection relation of the plurality of customer-possessing units, and providing the generated IM rebalancing projected path template to the IM managing backbone server so that the corresponding IM rebalancing projected path template is referred to when the IM rebalancing distribution channel setting information is set or reset by the customer.

11. The system for managing a distribution channel of IM according to claim 4, further comprising an IM rebalancing projected path template providing module controlled by the IM distribution channel management control module to communicate with the IM managing backbone server, wherein in case the IM rebalancing distribution channel setting information is being set or reset by the customer, the IM rebalancing projected path template providing module generates an IM rebalancing projected path template where a rebalancing projected path of the IM is displayed as a connection relation of the plurality of customer-possessing units, and provides the generated IM rebalancing projected path template to the IM managing backbone server so that the corresponding IM rebalancing projected path template is referred to when the IM rebalancing distribution channel setting information is set or reset by the customer.

12. The method for managing a distribution channel of IM according to claim 9, further comprising:
communicating with the IM managing backbone server, and in case the IM rebalancing distribution channel setting information is being set or reset by the customer, generating an IM rebalancing projected path template where a rebalancing projected path of the IM is displayed as a connection relation of the plurality of customer-possessing units, and providing the generated IM rebalancing projected path template to the IM managing backbone server so that the corresponding IM rebalancing projected path template is referred to when the IM rebalancing distribution channel setting information is set or reset by the customer.
